(19) United States
(12) Patent Application Publication
(10) Pub. No.: US 2018/0154359 A1
(43) Pub. Date: Jun. 7, 2018

(54) A SAMPLE STORAGE TUBE AND AN AUTOMATIC OPERATING SYSTEM FOR THE SAME

(71) Applicant: KOBE BIO ROBOTIX CO, LTD., Kato-shi, Hyogo (JP)

(72) Inventor: Yukio UEYAMA, Kobe-shi, Hyogo (JP)

(21) Appl. No.: 15/580,201

(22) PCT Filed: Mar. 14, 2016
(86) PCT No.: PCT/JP2016/057991

§ 371 Date: Dec. 6, 2017

(51) Int. Cl. B01L 3/00; G01N 35/04; G01N 35/00

(52) U.S. Cl. CPC B01L 3/50825; G01N 35/04; G01N 35/0099; G01N 35/00732; G01N 2035/00772; B01L 2300/041; B01L 2300/021; B01L 2300/024; B01L 3/5453

(57) ABSTRACT

[Problem to be solved] To provide a sample storage tube wherein the two-dimensional code and the wireless IC chip are equipped, and there is low interference between the two elements, which can ensure data reading and writing accuracy and reliability.

[Solution] A sample storage tube 100 comprise a tube body 120 for storing a sample; a lid 110 for capping the upper opening of the tube body; an information writable area 124 for writing information installed to a bottom surface of the tube body; wherein the information writable area 124 is arrayed in a peripheral portion of the bottom 123; and an information non-writable area 125 in which any information cannot be written is secured in a center part of the bottom 123. Plural of printed information codes 130 are printed on the information writable area 124. The sizes of the shapes of the printed information code are small, and the amount of the information carried by each printed information code is smaller than the amount of the information to be applied to the information writable area of the sample storage tube. The result obtained from the printed information codes 130 calculated by a predetermined algorithm equals the information writable area of the sample storage tube.

### TECHNICAL FIELD

This invention relates to a sample storage tube for storing and holding various samples. For example, the sample storage tube is used in holding and storing medicine samples being developed. Also, it is used for storing, refrigerating, freezing and preserving samples that hold gene information of DNA in the medical field. As such a sample storage tube becomes small, it is called a micro tube.

This invention relates to an automation system for capping a lid to a sample storage tube, decapping the lid from the sample storage tube, and carrying the sample storage tube by grabbing and moving it from the predetermined place to the other predetermined place by its robot arm.

### BACKGROUND ART

In the research and development of medicine and chemicals, sample storage tubes are used extensively in storing a large number of samples. For example, scientists prepare a large number of samples for a comparative experiment with slightly changing conditions such as blending amount, and they use storage tubes for storing the samples for a required period of time while evaluating them.

In order to control and store a large number of storage tubes at one time as described above, there are two types of the sample storage systems known in the prior art. The first type is a well-plate block type of sample storage container. The second type is a micro tube array type arraying a lot of sample storage containers of the micro tube type in the storage rack.

The micro tube array stores and contains each test sample in each small sample container, called the micro tube, piece by piece independently and arrayed in the storage rack. The micro tube is a container of about several centimeter height and made of plastic material. Each micro tube is an independent piece, and it is possible to use them as sample storage containers one by one. It is also possible to use as the micro tube array storing a lot of test samples at the same time by arraying a lot of micro tubes in the storage rack.

The micro tube comprises a tube body, which has an opening at the top, for storing the sample; and a lid for enclosing the opening of the tube body.

As the micro tubes are independent of each other and a large number of storage tubes are arrayed in a storage rack at the same time, it is necessary to identify each storage tube independently. In recent years sample storage tubes that are controlled by printing a barcode or two-dimensional code on the side and/or bottom surface of the storage tube are highlighted, in which various data and/or control information of a sample are encoded, and then the barcode or two-dimensional code is read in a control process.

In recent years IC chips that can be applied to the wireless communication device such as RFID become compact in size. The technology reads and writes the management information of the stored sample by IC chip stuck onto the surface of the micro tube or embedded into the sample storage tube.

FIG. 10 is a schematic view showing the conventional micro tube type sample storage tube on which the conventional code information is printed (JP Tokkai 2001-158450). FIG. 10 (a) shows a perspective view, FIG. 10 (b) shows an exploded view for showing the configuration.

In this configuration, the sample storage tube 10 comprises a transparent tube body 11; an outer element 12 installed to the outer surface of the tube body 11, a gasket 13 contacting the opening of the tube body 11 and a lid 14 for capping the opening of the tube body. The lid 14 is screwed with the outer element 12, and the gasket 13 seals the opening of the tube body 11 pressed by the inner surface of the lid 14.

In this example, the outer element 12 is made of black base plastic resin that can turn its color from black to white by laser irradiation. Bar code is printed onto the side surface and the two-dimension dot code is printed onto the bottom surface of the outer element 12. Bar code and two-dimension code in which the management information for identifying the sample stored in the micro tube 10 are printed onto the side surface and the bottom surface of the outer element 12 after storing the sample into the micro tube 10.

In recent years, an operation using the micro tube is enhanced by an automatic apparatus for capping the lid (capper) and decapping the lid (decapper) such as a robot arm. An operation using the micro tube is enhanced by an automatic apparatus for conveying from a predetermined position in the racks to another predetermined position. During the micro tube automated operation, each micro tube is identified by reading the coded information from the side surface and the bottom surface of the outer element 12.

FIG. 11 is a schematic view showing the example of the conventional micro tube in which the wireless communication IC chip such as RFID is installed (JP Tokkai 2011-215078). The upper drawing shows the side view of the whole micro tube, the lower drawing shows the enlarged view of the part of the bottom surface. Some of the inner structures are drawn by dotted lines to understand the inner structure easily.

An IC chip 3 is embedded in the bottom of the tube body 1. The IC chip is surrounded by the base wall 10 and the IC chip is sealed by the seal part 13. The IC chip 3 can be accessed for writing and reading data through wireless radio wave having a specific wavelength in a non-contact manner.
Prior art 1: JP Tokkai 2001-158450
Prior art 2: JP Tokkai 2011-215078

### DISCLOSURE OF THE INVENTION

### The Problems to be Solved

Miniaturization of micro tube is progressing. By using a small micro tube, a large number of micro tubes can be stored in a rack, so that the internal space of the expensive refrigerator apparatus or the freezer apparatus can be used effectively. Analysis techniques for the samples are improved. The amount of the sample to be stored in the inside of the apparatus also becomes small, and as a result the micro tube can be miniaturized. Therefore, information such as numerals characters observable by the human eye cannot be printed on the surface. All information should be coded and printed by the printed information code or should be written in the wireless IC chip.

A variety of automatic operations with respect to the micro tubes are also developed. The micro tubes are handled by a variety of automatic machines such as the automation apparatus for capping the lid (capper), the automation apparatus for removing of the lid (decapper), the automation apparatus for picking the micro tubes up from the rack, the automation apparatus for conveying the micro tubes, the automation apparatus for storing into the rack and the automation apparatus for applying to a sample analyzer. Each operation requires the identification of each micro tubes accessed by the automation apparatus. Therefore, the read/write processing mechanism for the information carried by each micro tube should be unified among the automation apparatus. If the printed information code printed onto the micro tube is shown as FIG. 10, the read/write processing mechanism using laser beam for the printed information code should be unified. If the micro tube includes a wireless IC chip shown as FIG. 11, the read/write processing mechanism using wireless radio wave should be unified.

However, there are a large number of systems in the market, and some suppliers mainly employ the reading/writing processing mechanism for the printed information code by using the laser beam, while other suppliers mainly employ the reading/writing processing mechanism for the IC chip using wireless radio wave. Therefore a user cannot apply the apparatus freely from the point of view of cost effectiveness.

For this purpose, there is a demand for the sample storage tube providing both the printed information codes and the wireless IC chip on the bottom surface of the micro tube.

However, there is a problem that both the printed information codes and the wireless IC chip cannot be simply provided on the bottom surface of the micro tube.

A first problem is a problem of heat generation during writing the printed information codes by laser beam. When printing the printed information codes, a coloring agent included to a plastic resin turns its color by heat generated by laser beam. Therefore, it is necessary to arrange the wireless IC chip separately from the printed information code.

FIG. 8 is a schematic view showing an example of an arrangement in the case where a printed information code and a wireless IC chip are overlapped with each other at the center portion.

As shown in FIG. 8, the printed information code 30 such as one-dimensional code and two-dimensional code is printed and the wireless IC chip 40 is embedded under the surface of the bottom of the micro tube 20. The thickness of the plastic resin between the printed information code 30 and the wireless IC chip 40 is “d”. As the micro tube is miniaturized, the restriction in the height direction becomes strict, and a sufficient thickness “d” cannot be secured so the thickness “d” cannot help being thin.

As shown in FIG. 8 (b), in order to develop coloring agent contained in a plastic resin material, when laser beam is irradiated on the surface of the bottom of the micro tube, heat is generated locally for color development. Since the thickness “d” to the wireless IC chip embedded in the bottom is small, heat generated by the laser beam is transmitted to the wireless IC chip. The wireless IC chip is weak in heat resistance and heat generated by the laser beam can cause damage and the reliability of the wireless IC chip can be deteriorated.

Therefore, the wireless IC chip must be spaced apart from the printed information codes. There is a limitation such that the printed information codes and the wireless IC chip cannot be arranged in a superimposed manner at the center.

The second problem is that the arrangement of both the wireless IC chip and the printed information code must be arranged in the center according to a conventional technology to ensure data read/write accuracy and data reliability and to confirm the position of the micro tube in the rack. The position of the micro tube cannot be confirmed precisely if the wireless IC chip and the printed information code are not located in the center of the bottom of the micro tube. This requirement is not compatible with the requirement of the first problem described above.

FIG. 9 is a schematic view showing a configuration that a printed information code and a wireless IC chip are arranged and shifted from the center position each other so as not to overlap each other.

In the example shown in FIG. 9, the micro tube 20 has a printed information code 30 such as a one-dimensional code and a two-dimensional code arranged on the one side of the surface of the bottom, and the wireless IC chips 40 is arranged on the other side of the surface of the bottom.

FIG. 9 (b) is a schematic view showing an appearance seen from the bottom surface. A portion of the rack is shown and plural micro tubes 20 are arranged in a matrix. As shown in FIG. 9 (b), the contained state of micro tubes 20 varies in the rotation angle in the circumferential direction with respect to the central axis. There is no practical way that the rotation angles in the circumferential direction with respect to the central axis are aligned in the same direction.

In the recognition processing of a printed information code 30, each position of the printed information code 30 is recognized. However, as shown in FIG. 9 (b), the interval between adjacent printed information codes varies widely. It is difficult to clip each printed information code 30 separately by the image processing and there is a possibility that an error may occur in the clipping processing.

The wireless IC chip 40 has the same problem. If the position of the micro tube is recognized by the wireless IC chip 40, the interval between adjacent wireless IC chips 40 varies widely, and it becomes difficult to recognize the position by using the wireless IC chip 40.

The third problem is a limitation of the surface state for the wireless IC chip.

Some wireless IC chips require the condition of being attached to the surface of the object or being covered by the light transmissive material covering the surface of the object even if the wireless IC chip is embedded in the object. These wireless IC chips employ dual methods of data input/output in which image processing and wireless radio wave are combined. In order to specify the position of the wireless IC chip, it is necessary to read a mark on the surface of the wireless IC chip and to specify the position of the wireless IC chip. In order to specify a position of the wireless IC chip by image processing, the wireless IC chip should be embedded in the center of the bottom surface of the micro tube from the restriction described in the second problem. A region where the wireless IC chip is embedded should be formed by the light transmissive material, so that the printed information code cannot be provided. On the other hand, the printed information code should be printed in the center of the bottom surface of the micro tube from the restriction described in the second problem, but the printed information code cannot be provided there because the center portion should be formed by the light transmissive material.

In this way, while the micro tube is miniaturized, it is not practical to use the conventional technology for printing an one-dimensional code or a two-dimensional code and embedding the wireless IC chip in the center position of the bottom surface of the micro tube at the same time.

It is an object of the present invention in view of the above problems to provide a sample storage tube and an automatic operating system for a sample storage tube in which the two-dimensional code can be printed and the wireless IC chip can be embedded in the bottom surface of the sample storage tube, the interference between the two-dimensional code and the wireless IC chip is small, and the data reading and writing accuracy and the data reliability are secured even if the micro tube is miniaturized.

### Means for Solving the Problems

In order to achieve the above-mentioned object, the present invention of a sample storage tube for storing a sample in a tube body comprises; a tube body for storing a sample; a lid for capping the upper opening of the tube body; and an information writable area for writing information installed to a bottom surface of the tube body; wherein the information writable area is arrayed in a peripheral portion of the bottom of the tube body; and a information non-writable area in which information cannot be written is secured in a center part of the bottom of the tube body.

According to the above-mentioned configuration, if the printed information code is selected as a small size which can write in the information writable area, a plurality of the printed information codes are distributed and can be printed in the peripheral portion of the bottom of the tube body. The capacity of the information carried in a printed information code depends on the size of the printed information code. The present invention can employ the printed information code which cannot carry enough information data amount for the information to be applied to a sample storage tube. The present invention can employ such printed information code which can carry insufficient data amount by printing a group of the printed information codes to the information writable area if the information to be carried in a sample storage tube can calculate by combining respective code information carried by each printed information code. If the calculated result from a group of the code information carried by a group of the printed information code by applying a predetermined algorithm equals to the information to be carried in a sample storage tube, such small size printed information code can carry a larger data amount by employing plural small size printed information codes.

For example, two-dimension dot code encoded by general specification can be employed as the printed information code, and the information to be carried in a sample storage tube is encoded to a combination of the independent small size printed information codes. In this manner, a group of small size printed information codes which small size printed information code can carry small data amount is prepared and printed on the dispersed information writable areas.

All small size printed information code in a combination can be the same type of the two-dimension dot code or the different type of the two-dimension dot code.

When a group of the small size printed information codes distributed are printed in the information writable area of each sample storage tube and plural sample storage tubes are arrayed in a rack and an image is taken from the lower direction of the rack, it is necessary for obtaining the correct information data to identify which combination of the sample storage tubes in the image is the correct combination of the sample storage tubes. For identifying the correct combination of the sample storage tubes, it is preferable that at least one of the printed check information codes is added appropriately to each group of the combination of the printed information codes and printed in the information writable area. The correct information data applied to the sample storage can be obtained by identifying the correct group of the printed information codes in the captured image and calculating the encoded information from the identified group of the printed information code by applying a predetermined algorithm.

There are various shapes to be employed as the bottom shape of the micro tube. There are various types of the two-dimension code such as QR code and Data matrix to be employed as the printed information code.

The first pattern is that the bottom shape of the micro tube is circle and the printed information code is two-dimension code encoded by general specification.

In this first pattern, plural general two-dimension codes are printed in the information writable area radially from the center of the bottom.

The second pattern is that the bottom shape of the micro tube is square and the information writable areas are arranged in each corner, and the printed information code is two-dimension code encoded by general specification.

In this second pattern, plural general two-dimension codes are printed in the information writable area arranged in each corner of the bottom.

A various functions can be equipped to the information non-writable area in the center of the sample storage tube.

For example, data input output function via a wireless IC chips can be equipped by embedding the wireless IC chips in the information non-writable area or attaching the wireless IC chip to the surface of the information non-writable area.

According to the above-mentioned configuration, both printed information code and wireless IC chips can be arrayed in the bottom surface of the sample storage tube without interfering with the installation positon of the wireless IC chip and the print position of the printed information code. In addition to the printed information code, the wireless IC chip can carry the information, and respective information carried by the printed information code and carried by the wireless IC chip can be used in combination.

For example, observation function for the sample stored in the sample storage tube through the information non-writable area can be enabled.

The inner sample state can be observed by light irradiated from a light irradiation apparatus to the light detection apparatus wherein the light irradiation apparatus is provided on either the upper side of the lid body or below the bottom surface and a light detecting apparatus is provided on the other side, if the light transmissive material is employed as the material for the information non-writable area in the bottom and for the lid portion corresponding to the information non-writable area.

There are several methods for manufacturing the information non-writable area as transmissive area and the information writable area as coloring area.

The first method is that the information non-writable area and the information writable area are molded by two-color molding apparatus, and at least the information non-writable area is formed by the light transmissive material and the information writable area is formed by the coloring material containing the color developer for printing the printed information codes onto the information writable area.

The second method is that the whole sample tube body is molded with the light transmissive material by a molding apparatus, and at least the information writable area is coated or printed with the coloring material containing the color developer for printing the printed information codes.

Either method can ensure that the light transmissive characteristic for the information non-writable area and the coloring characteristic by laser beam for the information writable area.

Next, an automatic sample storage tube operating system for reading and decoding the encoded information carried in the sample storage tube of the above-mentioned invention comprises an imaging part for taking a picture image of the sample storage tube from the bottom direction; an image recognition part for reading the printed information codes included in the picture image obtained by the imaging part; a grouping part for grouping the printed information codes by using the check result as a hint for searching the printed information codes belonging to the same group obtained by the image recognition part; coded information calculating part for calculating the coded information given to the sample storage tube by combining information carried in plurality of the printed information codes belonging to the same group grouped by grouping part; and a wireless communication for reading the information carried in the IC chip.

### Effect of the Invention

According to the sample storage tube of the present invention, the information data to be applied to the sample storage tube can be encoded into the combination of a group of the small size printed information code, without using the larger size printed information code that can carry the information data. The large amount of the information can be encoded and printed in the information writable area by securing the information writable area in the circumference area of the bottom surface and securing the information non-writable area in the center portion area of the bottom surface. The printed information code printed in the information writable in the circumference area does not interfere with the information non-writable area in the center portion area.

As an applicable example, if a wireless IC chip is embedded in the information non-writable area, the printed information codes can be arrayed and printed in the information writable area without interfering with each other. The access method for reading the information carried in the sample storage tube is that the information carried in the printed information codes are read by decoding the code from the captured image, the information carried in the wireless IC chip are read by wireless communication.

If the information non-writable area is formed by the light transmissive material, the sample stored in the sample storage tube can be observed through the information non-writable area as an window.

An automatic sample storage tube operating system can perform correct grouping from plural printed information codes in the captured image captured from the lower direction to the bottom of the sample storage tubes arrayed in a rack, and information carried by the combination of the printed information codes can be calculated from the combination of each encoded information to each printed information code by the predetermined algorithm. In addition, the information carried by the wireless IC chip is read by wireless communication.

### BRIEF DESCRIPTION OF THE DRAWINGS

FIG. 1 is a schematic view of the structure of the sample storage tube 100 of the first pattern.

FIG. 2 is an enlarged schematic view showing the enlarged image of the information non-writable area 124, information writable area 125, the printed information codes 130 and the wireless IC chip 140 of the first pattern.

FIG. 3 is a schematic view showing the captured image captured from the lower direction to the bottom of the sample storage tube wherein plural sample storage tubes arrayed in a rack.

FIG. 4 is a schematic view of the structure of the sample storage tube 100a of the second pattern.

FIG. 5 is a schematic view showing the captured image captured from the lower direction to the bottom of the sample storage tube wherein plural sample storage tubes arrayed in a rack.

FIG. 6 is a bottom view of the bottom 123 of the tube body 120 formed by the two-color injection molding.

FIG. 7 is a schematic view of the structure of the sample storage tube 100c of the Embodiment 3.

FIG. 8 is a schematic view showing an example of an arrangement in the case where a printed information code and a wireless IC chip are overlapped with each other at the center portion.

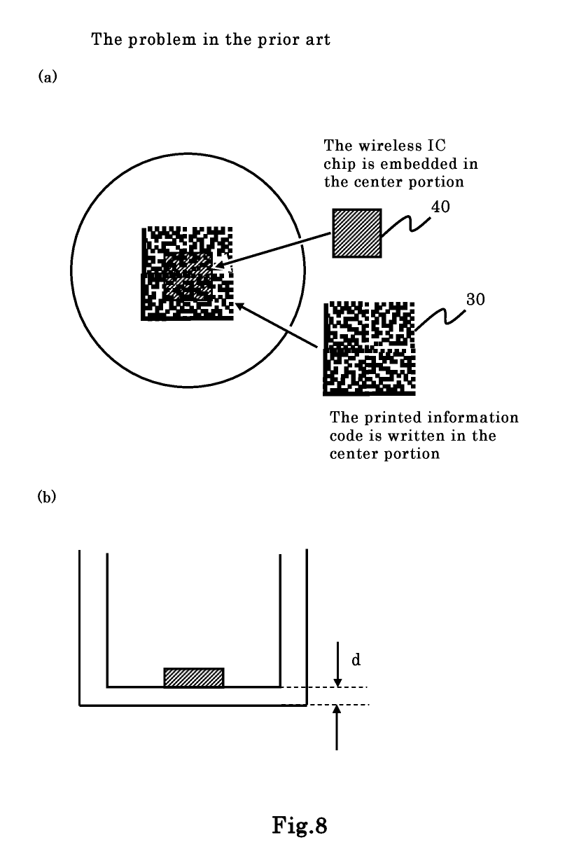

FIG. 9 is a schematic view showing a configuration that a printed information code and a wireless IC chip are arranged and shifted from the center position each other so as not to overlap each other.

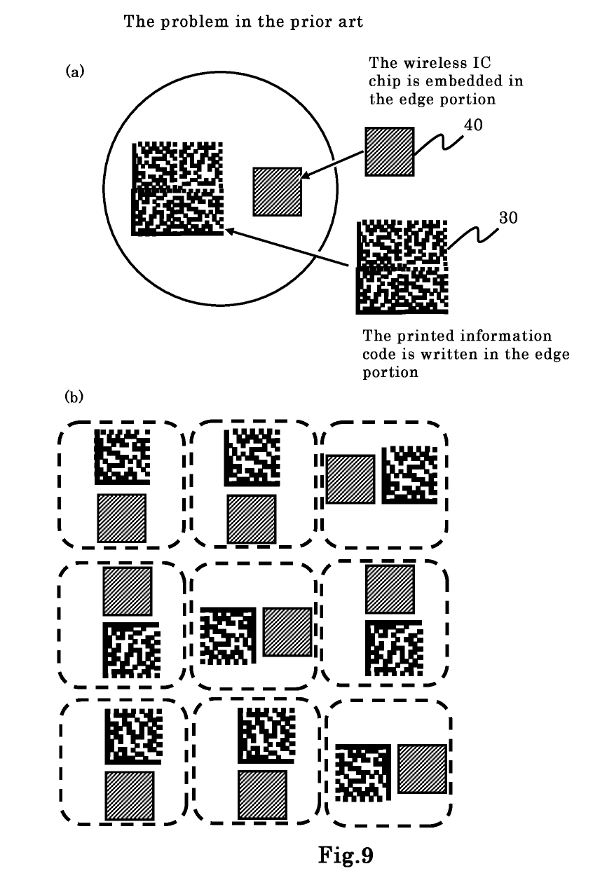

FIG. 10 is a schematic view showing the conventional micro tube type sample storage tube having the conventional code information is printed (JP Tokkai 2001-158450).

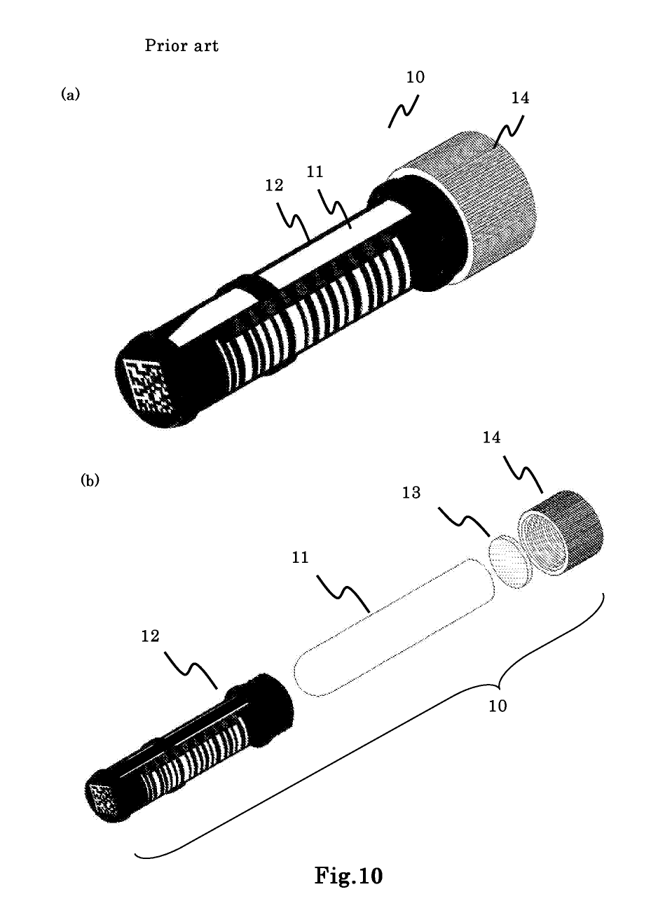

FIG. 11 is a schematic view showing the example of the conventional micro tube in which the wireless communication IC chip such as RFID installed (JP Tokkai 2011-215078).

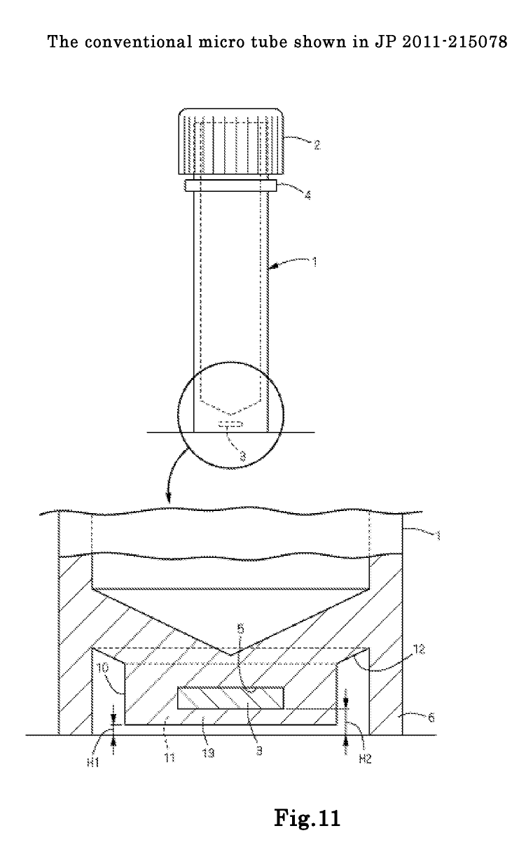

### DETAILED DESCRIPTION OF THE PREFERRED EMBODIMENT

Some embodiments of a sample storage tube and an automatic sample storage tube operating system according to the present invention are described below with reference to the relevant drawing. Needless to add, the claims of the present invention include but are not limited to the application, configuration, or quantity shown in the following embodiments.

As shown below, Embodiment 1, 2, 3 and 4 are explained in this order.

Embodiment 1 shows the structure of the sample storage tube 100 of the first pattern. The sample storage tube 100 of the first pattern has the configuration in which the bottom shape of the micro tube is circular and the printed information code is two-dimension code encoded by general specification. The wireless IC chip is embedded in the information non-writable area.

Embodiment 2 shows the structure of the sample storage tube 100a of the second pattern. The sample storage tube 100a of the second pattern has the configuration that the bottom shape of the micro tube is polygon (for example, square) and the information writable areas are arranged in each corner, and the printed information code is two-dimension code encoded by general specification. The wireless IC chip is embedded in the information non-writable area. In addition, other bottom shape designs are shown.

Embodiment 3 shows the structure of the sample storage tube allows observing of the sample stored in the sample storage tube through the information non-writable area without a wireless IC chip.

### Embodiment 1

The sample storage tube 100 in embodiment 1 according to the present invention is described.

Embodiment 1 shows the structure of the sample storage tube 100 of the first pattern. The sample storage tube 100 of the first pattern has the configuration in which the bottom shape of the micro tube is circular and the printed information code is two-dimension code encoded by general specification. The wireless IC chip is embedded in the information non-writable area. In this example the sample storage tube is formed by the two-color injection molding. However, the manufacturing method is not limited to the two-color injection molding.

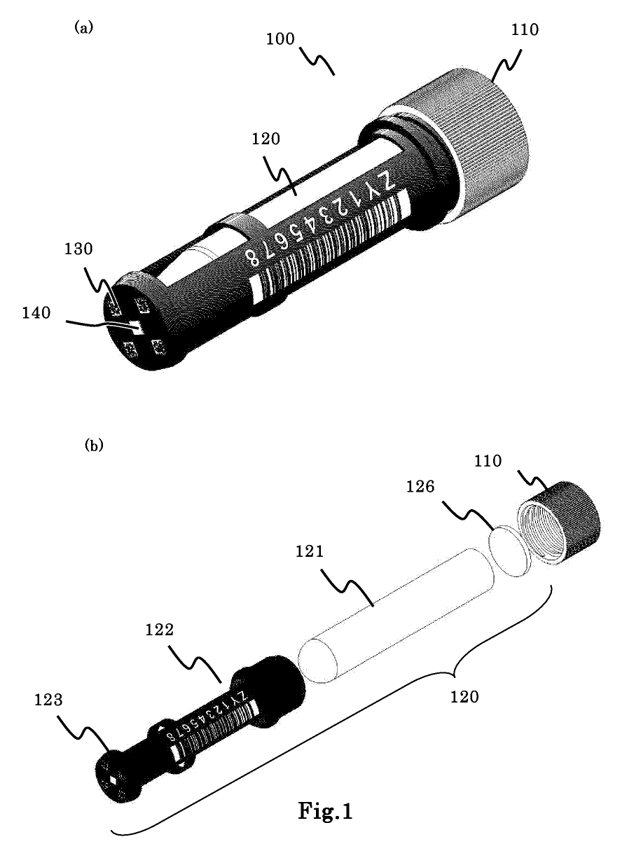

FIG. 1 is a schematic view of the structure of the sample storage tube 100. This example employs an outer screw type, but an inner screw type can be employed instead. FIG. 1 mainly shows the bottom of the sample storage tube 100 because the bottom structure is important.

FIG. 1 (a) is a perspective view emphasizing the bottom structure.

FIG. 1 (b) is an exploded view.

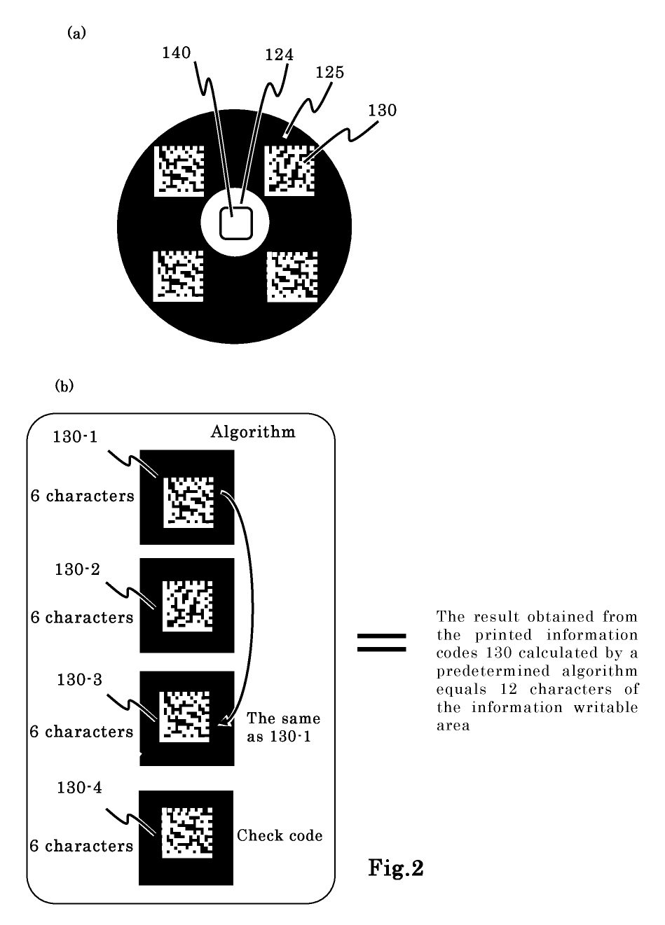

FIG. 2 is an enlarged schematic view showing the enlarged image of the information non-writable area 124, information writable area 125, the printed information codes 130 and the wireless IC chip 140 of the first pattern.

The sample storage tube 100 comprises a lid 110, a tube body 120, a printed information code 130 and a wireless IC chip 140.

The lid 110 has a lid structure for capping the upper opening of the tube body 120. The lid 110 and the tube body 120 are connected by screwing.

In this example, the lid 110 has a cylindrical shape.

It is preferable that the material of the lid 110 is a plastic resin (such as polypropylene, polyethylene and polycarbonate) having a chemical resistance property. A blended material selected from those materials can be employed as a material. In this example, the material is polypropylene. Polypropylene is an appropriate material as the membrane of the sample storage tube which has chemical stability and has chemical resistance.

Next, the tube body 120 is described.

The tube body 120 is a container for storing a sample. A container comprises an information writable area in the bottom can be employed as the tube body 120. Other element is not limited.

The configuration of the tube body 120 comprises an inner cylinder body 121, an externally equipped element 122, a bottom 123, an information non-writable area 124, an information writable area 125 and a gasket 126.

Regarding the height of the tube body 120, if the tube body 120 is held in the rack, it is preferable that height of the tube body 120 is higher than that of the grid plate of the rack. The sample storage tube 100 is inserted to and picked up from the rack repeatedly. If the upper portion of the tube body 120 is projecting from the rack top surface in the stored state in rack, the sample storage tube body is easy to access with the robot arm.

The inner cylinder body 121 is a test tube shape container for storing sample.

The inner cylinder body 121 is formed by a light transmissive material to allow observing of the inner space.

It is preferable that the material of the lid 121 is a glass or a plastic resin having a transparent characteristic or translucent characteristic to observe the inner space. It is preferable that the material has the high chemical resistance property (such as polypropylene, polyethylene and polycarbonate). The blended material selected from those materials can be employed as a material. In this example, the transmissive material is polypropylene. Polypropylene is an appropriate material as the membrane of the sample storage tube which has chemical stability, chemical resistance property and high transparency.

An externally equipped element 122 is equipped outside to the inner cylinder body 121 throughout from the bottom surface to the side surface. The externally equipped element 122 is formed by the black color plastic resin in which a coloring agent is included to turn its color from black to white by heat generated by laser beam, which is used as a medium in which printed information codes can be written directly. In this example, the externally equipped element 122 has a cylindrical shape, but other element can be added depending on the use. For example, it may comprise a rotation preventing object at the side wall surface or the bottom surface of the cylindrical body that contacts the structure of the rack to block the rotation. For example, a plurality of wing shape protrusions are installed at the bottom of the cylindrical body of the externally equipped element 122 in a radial pattern. If a plurality of wing shape protrusions are also installed to the rack, the wing shape protrusions engage each other to prevent the externally equipped element 122 from rotating even though a rotation torque is applied to the tube body 120. If the rotation of the tube body 120 can be blocked, the tube body 120 does not rotate even though the rotation torque is transmitted via the lid 110 by the automation robot arm. The capping operation and the decapping operation can be operated precisely.

Next, the bottom 123 is described.

FIG. 2 is an enlarged schematic view showing the enlarged image of the bottom 123. The bottom 123 is an element to seal the bottom of the externally equipped element 122, in this example, its shape is a circular plate as shown in FIG. 1.

The bottom 123 includes the information non-writable area 124 in the center portion and the information writable area 125 surrounding the information non-writable area 124.

The information non-writable area 124 is an area where the printed information codes 130 are not written. In this example, the information non-writable area 124 is used as the area for embedding the wireless IC chip 140.

In this example, the information non-writable area 124 is formed by a transparent material, and the embedded wireless IC chip 140 can be seen through it. If it is not necessary for the wireless IC chip 140 to be seen by an operator, the whole bottom 123 can be formed by the black color material.

The information writable area 125 is located outside of the information non-writable area 124. The information writable area 125 is formed by the black color plastic resin in which a coloring agent is included to turn its color from black to white by heat generated by laser beam. In this example, plural printed information codes 130 are written dispersedly in the information writable area 125.

The printed information code 130 is a printed figure carrying the encoded information such as two-dimensional dot codes. In this configuration, the data amount of the encoded information carried by a printed information code 130 is smaller than that of the information to be applied to a sample storage tube 100, so that plural encoded information carried by plural printed information codes 130 are combined and calculated to obtain a larger information by using a predetermined algorithm processing. For example, the data amount of the information to be applied to one sample storage tube 100 is 16 bits and the requested size for carrying the 16 bits data amount by a single figure is “R”, and the size of the printed information codes 130 of the present invention is “r”, which is smaller than “R”. Therefore, the data amount of the printed information code 130 of the present invention is less than 16 bits, for example, 8 bits. The size of the printed information codes 130 of the present invention becomes compact size according to its carriable data amount. The size “r” is smaller than “R”. The “small size printed information code” does not mean a merely small fragment obtained by cutting the large size two-dimensional code into small pieces physically. Each printed information codes 130 of the present invention is an independent two-dimensional code even if it is small. It is an independent two-dimensional code which can be decoded independently even though the carriable encoded information is small. A single printed information codes 130 of the present invention cannot provide the whole information to be applied to the sample storage tube but a combination of a group of the printed information codes 130 of the present invention can provide the whole information to be applied to the sample storage tube by calculating based on each decoded information carried by each printed information code 130 of the present invention according to the predetermined algorithm processing.

For example, information to be applied to the sample storage tube is 16 bits, and it is separated into a set of 8 bits of data. Each 8 bits of data can be encoded to a small size two-dimensional code which can carry 8 bits. These small size two-dimensional codes correspond to the printed information code 130 of the present invention. If there are only two decoded information decoded from two small size two-dimensional codes, it is not sure which 8 bits are upper portion data and which 8 bits are lower portion data. It is not possible to obtain precise data by merging two decoded information. Therefore, information describing how to re-build 16 bits data from two pieces of 8 bits data is needed. There are many logics for dividing 16 bits data into two pieces of 8 bits of data and re-building 16 bits data from two pieces of 8 bits data. This invention is not limited to a specific logic. This invention provides technical idea for carrying the large information data to be applied to a sample storage tube by the smaller size two-dimensional code.

The printed information code 130 is printed in the information writable area 125 radially from the center of the bottom 123. In this example, 4 pieces of the printed information codes 130 are printed, which are provided 90° apart from each other on the circumference around a center portion as shown in FIG. 2 (a).

FIG. 2 (b) is a schematic view showing the size of the printed information code 130 of this first pattern. The printed information code 130 of this first pattern employs a two-dimensional code encoded by general specification. In this example, the DataMatrix code system is employed as the two-dimensional code encoded by general specification.

In this example, the information to be applied to a sample storage tube 100 comprises 12 characters.

The left of the FIG. 2 (b) describes the procedure for processing 4 sets of decoded information obtained from two-dimensional code 130-1 to 130-4, calculated with a predetermined algorithm. For example, if the size of each two-dimensional code 130-1 to 130-4 is 10 cells×10 cells, the carriable data amount corresponds to 6 characters. If the width per one cell is 0.16 mm, the size of the printed information code becomes 1.6 cm×1.6 cm=2.56 cm². The information to be applied to the sample storage tube 100 is calculated from these 4 pieces of 6 characters with the predetermined algorithm.

Each printed information code 130-1 to 130-4 can carry data corresponding to 6 characters, so the 12 characters information to be applied to the sample storage tube 100 can be divided into 6 characters and be assigned to the printed information codes. For example, the former 6 characters is assigned to the printed information code 130-1, the latter 6 characters is assigned to the printed information code 130-2.

In this case, the printed information codes 130-3 and 130-4 provide information for identifying the correct combination of 4 pieces of printed information codes among a lot of the printed information codes in the captured image and determining which ones are the printed information code 130-1 and 130-2.

For example, the printed information code 130-3 carries the information showing which printed information code is the printed information code 130-1 and which printed information code is the printed information code 130-2. For example, if there is a rule that the some printed information code as 130-1 is assigned to the printed information code 130-3, it is easy to determine the printed information code 130-1 by finding two of the same printed codes among 4 pieces. One of the remaining 2 pieces of the printed information code is the printed information code 130-2, and the other is the check code. The equal symbol shown in FIG. 2 (b), left 4 pieces of the printed information codes describes the former 6 characters and the latter 6 characters and equals to 12 characters.

The size of DataMatrix that can carry all 12 characters in one printed information code becomes 14 cells×14 cells. If the width per one cell is 0.16 cm, the size of DataMatrix is 2.24 cm×2.24 cm=5.02 cm². This size of DataMatrix can carry 12 characters data in one code. The size of the printed information code shown in FIG. 2 (b) is 2.56 cm², so the double size code should be required for carrying 12 characters data in one code.

The printed information code 130-4 is check code. For example, the printed information code 130-4 carries specific code information with which the calculating result of 4 pieces of the printed information code 130-1 to 130-4 becomes 0. By putting this check code into a combination of 4 pieces of the printed information codes, the correct group comprising 4 pieces of the printed information codes can be selected among a lot of printed information codes in the captured image.

The sample storage tube 100 is arrayed in a rack. For example, the rack space is partitioned by grid and the hole is opened onto the bottom, and the sample storage tube is housed by locking to the edge near the bottom of the grid. Therefore, a lot of printed information codes 130 are captured adjacent to each other in the captured image.

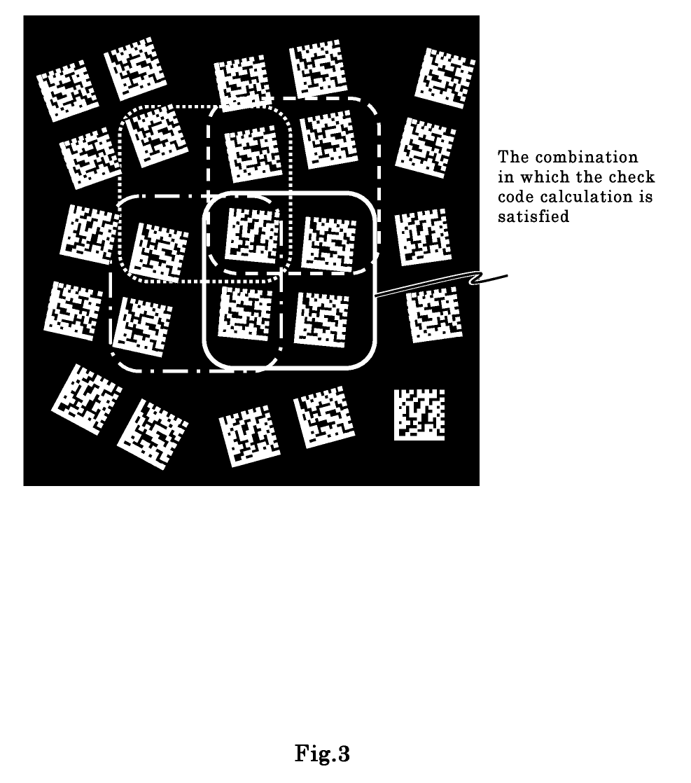

FIG. 3 is a schematic view showing the captured image captured from the lower direction to the bottom of the sample storage tube 100 which plural sample storage tubes 100 arrayed in a rack.

In this example shown in FIG. 3, all sample storage tubes 100 are arranged equally in the same direction in a rack. However, the outer shape of the externally equipped element 122 in the horizontal direction is a circle shape, so that the sample storage tube 100 can take various angles around the vertical axis. However, the principle of how to identify the correct combination of the printed information codes 130 can be applied regardless of this condition.

As shown in FIG. 3, an image is captured from the lower direction to the bottom of the rack by camera, and a lot of images of the printed information codes 130 can be seen in the captured image. At a glance, it is not known which combination of the printed information codes is correct for corresponding to a single sample storage tube 100. In the present invention, it is possible to check the combination by picking up 4 pieces of printed information codes adjacent to each other arbitrarily, and calculating the check code result becoming a specific value such as 0.

The example shown in FIG. 3 describes how to search the possible combination be focusing on the center printed information code 130 and picking up the remaining 3 printed information codes 130 adjacent to the selected center one. There are 4 candidates, including the combination surrounded by dotted lines, the combination surrounded by broken lines, the combination surrounded by dot-dash lines, and the combination surrounded by solid lines. The correct combination among those can be identified by calculating check code satisfaction. For example, the combination surrounded by dot lines, the combination surrounded by broken lines and the combination surrounded by dot-dash lines do not satisfy the check code calculation, but only the combination surrounded by solid lines satisfies the check code calculation. In this result, the combination surrounded by solid lines can be identified as the correct combination of 4 pieces of the printed information codes written in one bottom 123 for carrying information to be applied to the sample storage tube 100.

Once a correct combination is identified among a lot of printed information codes in the captured image by calculating check code, other combinations consisting of 4 pieces of the printed information code adjacent to each other are identified one after another by calculating the check code, and all correct combinations can be identified.

Next, the wireless IC chip 140 is described.

The wireless IC chip 140 is embedded in or stuck onto the information non-writable area 124 in the center portion of the sample storage tube 100. For example, a RFID type wireless IC chip encoded by general specification can be employed. Because of the wireless IC chip 140, the data can be input and output by the contactless means.

In this configuration, the wireless IC chip 140 is installed in the information non-writable area 124, no printed information code 130 is written by overlapping state by laser beam. Therefore, heat generated by the laser beam does not influence the wireless IC chip, and there is no heat damage to the wireless IC chip 140.

The color of the information non-writable area 124 is not limited. It is transparent in this example. Therefore, the wireless IC chip 140 can be seen from the lower direction to the bottom surface 123 through the information non-writable area 124 even if the wireless IC chip 140 is embedded into it.

According to the sample storage tube 100 of this embodiment 1 of this invention, both the printed information codes 130 and the wireless IC chip 140 can be installed to the bottom of the tube body without interference between the arrangement of the printed information codes 130 and the arrangement of the wireless IC chip 140. Therefore, the access means for accessing the information carried by the sample storage tube varies by means of reading the printed information codes in the captured image and by means of the wireless communication with the wireless IC chip.

Accordingly, the automatic operating system for a sample storage tube can obtain the necessary information carried by the sample storage tube arranged in a rack by capturing the image from lower direction to the bottom surface, grouping the correct combination of the printed information codes, decoding the encoded information from the printed information codes and calculating the information to be applied to the sample storage. In addition, information carried by the sample storage tube can be obtained by the wireless communication with the wireless IC chip.

### Embodiment 2

The second pattern of the sample storage tube in embodiment 2 according to the present invention is described. The sample storage tube in embodiment 2 employs the wireless IC chip embedded in the information non-writable area.

The second pattern is that the bottom shape of the micro tube is a polygon (for example, square) and the printed information code is two-dimension code encoded by general specification.

In this second pattern, plural general two-dimension codes are printed in the information writable area arranged in each corner of the bottom.

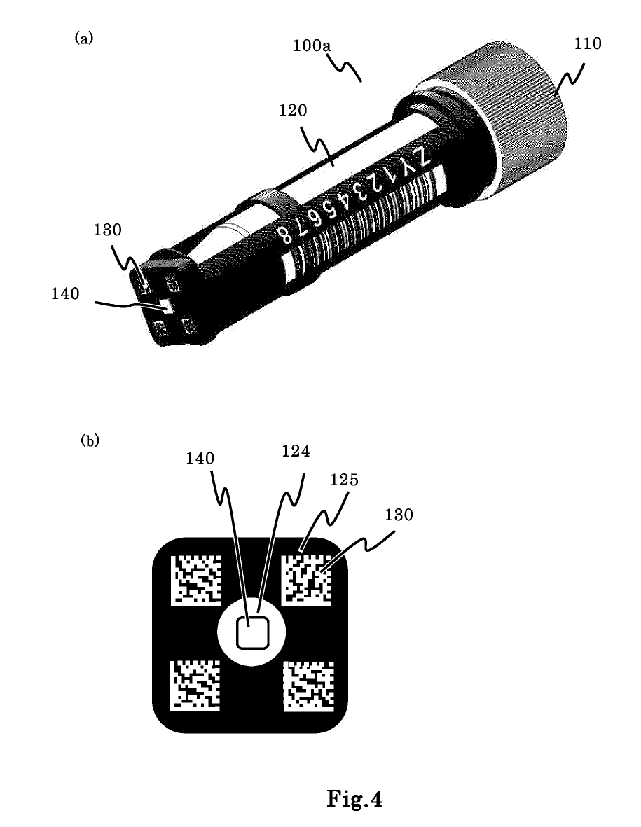

FIG. 4 is a schematic view of the structure of the sample storage tube 100a of the second pattern.

This example employs an outer screw type, but an inner screw type can be employed instead. FIG. 4 mainly shows the bottom of the sample storage tube 100a because the bottom structure is important.

FIG. 4 (a) is a perspective view emphasizing the bottom structure.

FIG. 4 (b) is an enlarged schematic view showing the enlarged image of the information non-writable area 124, information writable area 125, the printed information codes 130 and the wireless IC chip 140 of this second pattern.

Hereinafter, the element which is different from that shown in embodiment 1 is mainly described. The element which is the same as shown in embodiment 1 is omitted appropriately. The material and the function are the same as embodiment 1, but the shapes of some parts are different from embodiment 1.

The sample storage tube 100a of this second pattern comprises a lid 110, a tube body 120, a printed information code 130 and a wireless IC chip 140 the same as embodiment 1, but the bottom shape is square.

There are an information non-writable area 124 secured in the center portion of the bottom 123 and an information writable area 125 arranged around the information non-writable area 124. The printed information codes are written in each corner of the square shape of the bottom. The information writable areas 125 are made of black base plastic resin including coloring agent that can turn its color from black to white by laser irradiation, the same as embodiment 1.

The information non-writable area 124 of this embodiment 2 is secured in the center portion of the bottom. Its function is the same as that of embodiment 1.

The function of the information writable area 125 is also the same as embodiment 1 even though the shape is different.

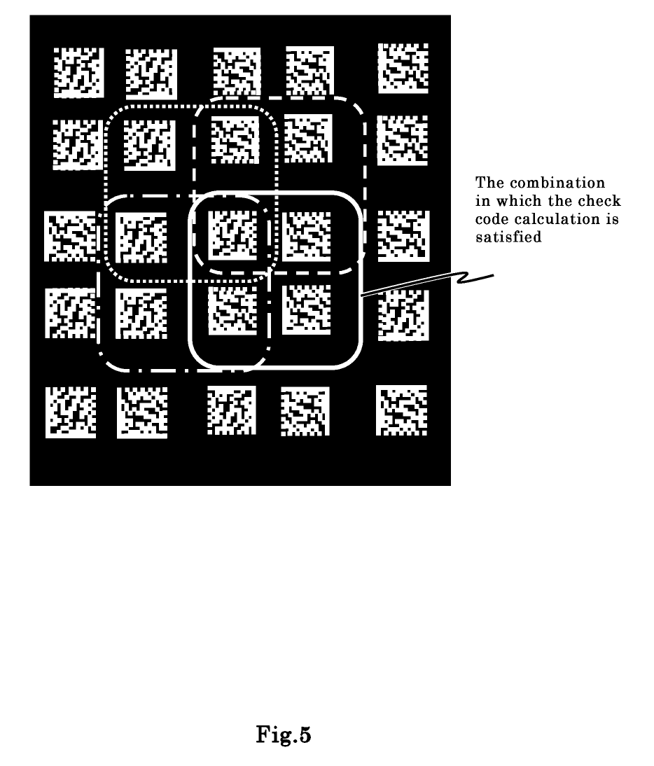

FIG. 5 is a schematic view showing the captured image captured from the lower direction to the bottom of the sample storage tube wherein plural sample storage tubes arrayed in a rack. In this example shown in FIG. 5, all sample storage tubes 100 are arranged equally in the same direction in a rack. However, the outer shape of the externally equipped element 122 in the horizontal direction is a square shape, so that the sample storage tubes 100 can take various rotation angles in increments of 90 degrees with respect to the central axis. However, the principle of how to identify the correct combination of the printed information codes 130 can be applied regardless of this condition. In this example, there are 4 pieces of the printed information codes 130 per one sample storage tube 100. One of four is a check code, so that the correct combination can be identified by calculating with the check code.

As shown in FIG. 5, an image is captured from the lower direction to the bottom of the rack by camera, and a lot of images of the printed information codes 130 can be seen in the captured image. At a glance, it is not known that which combination of the printed information codes is correct corresponding to one sample storage tube 100. In the present invention, it is possible to check the combination by picking up 4 pieces of printed information codes adjacent to each other arbitrarily, and calculating the check code result becoming a specific value such as 0.

In the example shown in FIG. 5, the combination surrounded by dotted lines, the combination surrounded by broken lines and the combination surrounded by dot-dash lines do not satisfy the check code calculation, but only the combination surrounded by solid lines satisfies the check code calculation. According to this result, the combination surrounded by solid lines can be identified as the correct combination of 4 pieces of the printed information codes written in one bottom 123 for carrying information to be applied to the sample storage tube 100.

Once a correct combination is identified among a lot of printed information codes in the captured image by calculating check code, other combinations consisting of 4 pieces of the printed information code adjacent to each other are identified one after another by calculating the check code, and all correct combinations can be identified.

The information can be obtained by reading the printed information code 130 and by communicating with the wireless IC chip 140.

As shown above, the principal of the present invention can apply regardless of the bottom shape of the sample storage tube such as circle and polygon, or the type of the printed information code such as bar code and two-dimensional code.

Various designs for the bottom shape of the tube body are shown below.

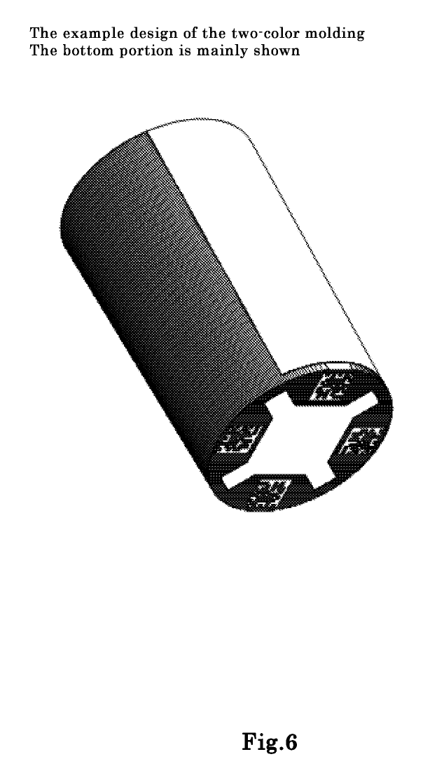

FIG. 6 is a bottom view of the bottom 123 of the tube body 120 formed by the two-color injection molding.

In this example, the tube body 120 is formed by molding a transparent inner cylinder tube onto an inner side of an externally equipped element whose shape is a half cylinder shape by two-color molding method. The bottom of the black color externally equipped element provides the information writable area 125 formed on each of 4 corners defined as a part of the bottom. The inner cylinder tube can be observed directly through the opening in the center portion. This center portion is an information non-writable area 124 and a wireless IC chip is embedded in there.

There are various types of designs for the tube body formed by two-color molding method. The present invention is not limited to the specified design. A tube body can be supplied by a two color molding method so that an information writable area 125 is formed as a part of the bottom 123 of the tube body 120 by the one material including coloring agent and an information non-writable area 124 is formed as a remaining part of the bottom 123 of the tube body 120 by the other material.

### Embodiment 3

Embodiment 3 describes the configuration sample storage tube of the present invention in which a wireless IC chip is not installed in the information non-writable area, and the inside of the inner cylindrical tube is observed through the center portion.

There are various combinations of the bottom shape, the shape of the information writable area and the types of the printed information code for the tube body that does not have any wireless IC chip. For example, the configuration shown in Embodiment 1 from which the wireless IC chip is eliminated and the configuration shown in Embodiment 2 from which the wireless IC chip is eliminated can be counted as the example of this Embodiment 3. As an example, the configuration with the bottom shape that is circular and the printed information code is two-dimensional dot code encoded by general specification can be used.

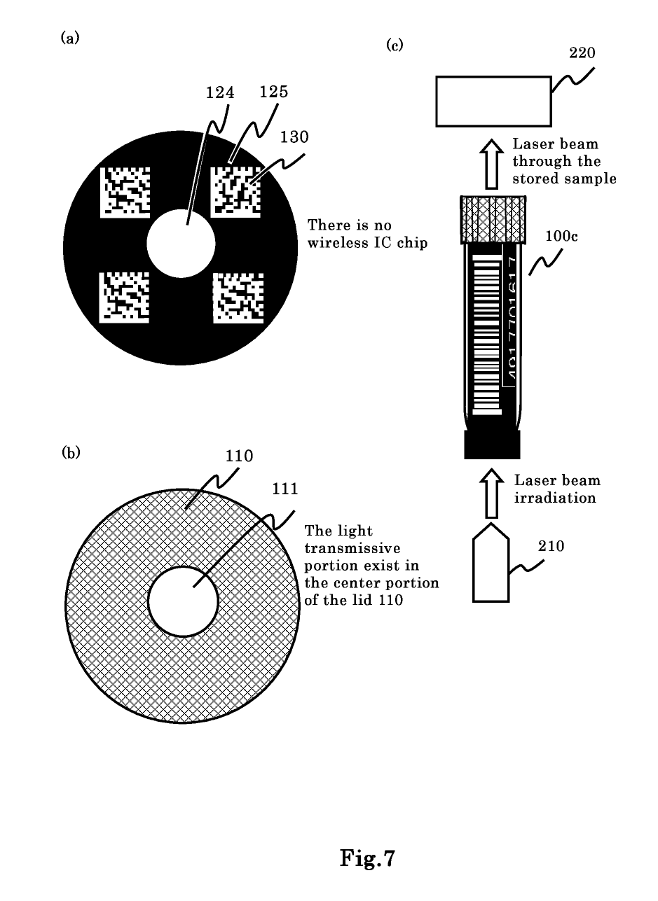

FIG. 7 is a schematic view of the structure of the sample storage tube 100c of the Embodiment 3.

FIG. 7 (a) is the bottom view.

FIG. 7 (b) is the plan view.

FIG. 7 (c) is the side view showing sample storage tube 100c with a light irradiation apparatus 210 and a photo detection apparatus 220 as an outer apparatus. FIG. 7 (c) shows its scale smaller than FIG. 7 (a) and FIG. 7 (b).

Hereinafter, a part different from that of Embodiment 1 is mainly described, and a part the same as that of Embodiment 1 is omitted. The material, the function, and the like are the same, and the shape of the member is different.

The same as Embodiment 1, the sample storage tube 100c includes a lid body 110, a tube body 120, and a printed information code 130. In this configuration example, a wireless IC chip 140 is not provided.

An information non-writable area 124 is provided at the center of a bottom surface 123 and an information writable area 125 is provided around the information non-writable area 124. The information writable area 125 is formed by a plastic resin material in which a coloring agent is included and it can turn its color by laser beam irradiation the same as shown in Embodiment 1.

The information non-writable area 124 of the third embodiment has the same shape as that of the information non-writable area 124 of the first embodiment but no wireless IC chip 140 is embedded in there. An information non-writable area 124 is formed by the same light transmissive material as shown in the first embodiment. The state of the internal sample can be observed through the information non-writable area 124 of the bottom 123 because there is no wireless IC chip embedded in there.

As shown in FIG. 7 (b), a part of a lid body 110 of a sample storage tube 100c is a light transmissive region 111. The position of the light transmissive region 111 corresponds to an information non-writable area 124 at the center of the bottom surface 123. With this construction, the light can pass through in the vertical direction from the light transmissive region 111 of the lid body 110 to the information non-writable area of the bottom surface 123, so that the state of the inside of the sample tube can be observed.

As shown in FIG. 7 (c), a light irradiation apparatus is provided on either the upper side of the lid body 110 or below the bottom surface 123 and a light detecting apparatus 220 is provided on the other side. In the configuration example shown in FIG. 7 (c), a light irradiation apparatus is provided below a bottom surface 123 and a light detecting apparatus 220 is provided above the lid body 110.

The light emitted from the light irradiation apparatus 210 passes through the inside of the sample storage tube 100c and receives the light detecting apparatus 220 so that the state of the inside of the sample tube can be observed.

The information writable area 125 and the printed information code 130, and the reading processing are the same as those of embodiment 1, so the description thereof is omitted here.

While some preferable embodiments of the sample storage according to the present invention are described above, it should be understood that various changes are possible, without deviating from the technical scope according to the present invention.

### INDUSTRIAL APPLICABILITY

A sample storage tube according to the present invention can be employed as a sample storage tube such as a micro tube used extensively for storing a large number of samples.

### DESCRIPTION OF THE REFERENCE NUMERALS

100 Sample storage tube
110 lid body
120 tube body
121 inner cylinder tube
122 externally equipped body
123 bottom
124 information non-writable area
125 information writable area
126 gasket
130 printed information code
140 wireless IC chip
210 light irradiation apparatus
220 light detecting apparatus

1. A sample storage tube comprising;
a tube body for storing a sample;
a lid for capping the upper opening of the tube body;
an information writable area for writing information at a bottom surface of the tube body;
wherein the information writable area is arrayed in a peripheral portion of the bottom of the tube body;
and a information non-writable area in which any information cannot be written is secured in a center part of the bottom of the tube body.

2. A sample storage tube according to claim 1, in which a plurality of printed information codes are distributed and printed around the peripheral portion of the bottom of the tube body,
wherein each printed information code has a shape corresponding to the information writable area size and each of them can be readable and decodable independently,
wherein the result obtained from the plurality of the printed information codes by using a predetermined algorithm applied to the read and decoded result from the encoded information carried in the printed information codes equals the information to be given to the sample storage tube.

3. A sample storage tube according to claim 2, wherein an IC chip is embedded in or stuck onto the information non-writable area in the center portion of the bottom surface accessible from the outside.

4. A sample storage tube according to claim 2, wherein at least one of the printed information codes is printed check information code that carries check information,
a group of the printed information codes distributed in the information writable area is recognized by the combination of the encoded information carried in the printed information codes and the check information carried in the printed check information code, and
the information to be given to the sample storage tube is obtained from the plurality of the printed information codes belonging to the same group by using the predetermined algorithm applied to the read and decoded result from the encoded information carried in the printed information codes.

5. A sample storage tube according to claim 2, wherein the bottom shape of the sample storage tube body is circular,
the shape of the printed information code is two-dimension dot code encoded by general specification, and
the printed information codes can be printed radially from the center portion of the information writable area of the bottom of the tube body.

6. A sample storage tube according to claim 2, wherein the bottom shape of the sample storage tube body is a polygonal shape,
the shape of the printed information code is two-dimension dot code encoded by general specification, and
the printed information codes can be printed onto the corner portion of the information writable area of the bottom of the tube body.

7. A sample storage tube according to claim 1, wherein the information non-writable area has light transmissive characteristic,
the lid portion corresponding to the information non-writable area of the bottom of the tube body has light transmissive characteristic, and
an inner sample state can be observed by light irradiated from a light irradiation apparatus to the light detection apparatus wherein the light irradiation apparatus is provided on either the upper side of the lid body or below the bottom surface and a light detecting apparatus is provided on the other side.

8. A sample storage tube according to claim 7, wherein the information non-writable area and the information writable area are molded by a two-color molding apparatus,
at least the information non-writable area is formed by the light transmissive material and the information writable area is formed by the coloring material containing the color developer for printing the printed information codes onto the information writable area.

9. A sample storage tube according to claim 7, wherein the whole sample tube body is molded with the light transmissive material by a molding apparatus,
at least the information writable area is coated or printed with the coloring material containing the color developer for printing the printed information codes.

10. An automatic operating system for sample storage tube for reading and decoding the encoded information carried in the sample storage tube described in claim 3, comprising;
an imaging part for taking a picture image of the sample storage tube from the bottom direction;
an image recognition part for reading the printed information codes included in the picture image obtained by the imaging part;
a grouping part for grouping the printed information codes by using the check result as a hint for searching the printed information codes belonging to the same group obtained by the image recognition part;
an coded information calculating part for calculating the coded information given to the sample storage tube by combining information carried in plurality of the printed information codes belonging to the same group grouped by grouping part;
and a wireless communication for reading the information carried in the IC chip.
